(19) United States
(12) Patent Application Publication
(10) Pub. No.: US 2006/0055295 A1
(43) Pub. Date: Mar. 16, 2006

(54) Plasma Display panel device

(76) Inventors: Myung-Gi Shim, Suwon-si (KR); Dong-Gun Moon, Suwon-si (KR); Jun-Kyu Cha, Suwon-si (KR); Ik-Chul Lim, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/223,663

(22) Filed: Sep. 9, 2005

(30) Foreign Application Priority Data
Sep. 10, 2004 (KR) 10-2004-0072460

(51) Int. Cl. H01J 61/40

(52) U.S. Cl. 313/112; 313/582

(57) ABSTRACT

A plasma display panel (PDP) device having a film filter is disclosed. In one embodiment, the PDP device includes a panel, a conductive layer formed along an edge of a front surface of the panel, and a film filter including an electromagnetic wave absorption layer at least a portion of which contacts the conductive layer, and attached onto the front surface of the panel, wherein the electromagnetic wave absorption layer is configured to absorb electromagnetic wave emitted from the front surface of the panel.

### CROSS-REFERENCE TO RELATED PATENT APPLICATIONS

This application claims the benefit of Korean Patent Application No. 10-2004-0072460, filed on Sep. 10, 2004, in the Korean Intellectual Property Office, the disclosure of which is incorporated herein in its entirety by reference.

### BACKGROUND OF THE INVENTION

1. Field of the Invention

The present invention relates to a plasma display panel device, and more particularly, to a plasma display panel device including a film filter.

2. Description of the Related Technology

In general, in a plasma display panel device, a glass filter is disposed in front of a panel with a predetermined gap formed therebetween. The filter improves the quality of the display, for example, by shielding electromagnetic waves harmful to human beings and blocking near infrared-rays which causes a problem with the use of a remote controller. Furthermore, the filter prevents neon from being emitted, and prevents external lights from being reflected by a front surface of the panel. Among the various functions of the filter, the most important one is to shield against electromagnetic waves.

FIG. 1 is a schematic exploded perspective view of a conventional plasma display panel device.

Referring to FIG. 1, the plasma display panel device includes a panel 11 including a front glass substrate and a rear glass substrate, a chassis 12 fixing and holding the panel 11, and an electronic circuit board 13 installed on a rear surface of the chassis 12. A glass filter 15 is installed in front of the panel 11. The panel assembly11, the chassis 12, and the glass filter 15 are installed in a space defined by a front cover 16 and a back cover 14.

The conventional glass filter 15 shown in FIG. 1 is multiple layers which is formed by coating a material on the surface of a glass substrate. The filter 15 is formed of a tempered glass in order to prevent the display device from being damaged by an external shock. The glass filter 15 is separated from the panel 11 a predetermined distance of about 5˜10 mm.

Although the plasma display panel is generally thinner than any other display devices, the glass filter 15 increases the total weight of the plasma display panel device. For example, the glass filter 15 weighs as much as about 10% of the entire device weight. In addition, the gap formed between the glass filter 15 and the panel 11 increases the total thickness of the device.

### SUMMARY OF CERTAIN INVENTIVE ASPECTS

One aspect of the present invention provides a plasma display panel device including a film filter.

Another aspect of the present invention provides a plasma display panel device having an improved coupling structure between a film filter and a plasma display panel.

Another aspect of the present invention provides a plasma display panel device including: a panel, a conductive layer formed along an edge of a front surface of the panel, and a film filter including an electromagnetic wave absorption layer contacting the conductive layer formed on the front surface of the panel, and attached onto the front surface of the panel.

In one embodiment, the conductive layer may be formed of at least one of the following metals: Ag, Au, Cu, Al, Pt, Ni, Pb, Co, Rh, Ru, Sn, Ir, Pd, and Ti.

In one embodiment, the conductive layer may be formed by printing, sputtering, or depositing a paste.

In one embodiment, the plasma display panel device may further include a chassis disposed on a back surface of the panel to fixedly maintain the panel, the chassis being electrically connected to the conductive layer.

In one embodiment, the plasma display panel device may further include a front cover and a rear cover receiving the panel, the film filter, and the chassis therein.

Another aspect of the present invention provides a plasma display panel device including: a panel, a film filter attached on a front surface of the panel and including an electromagnetic wave absorption layer, and a conductive tape attached to the electromagnetic wave absorption layer, and extending along edges of a first surface and a second surface of the film filter.

In the above aspect, the plasma display panel device further comprises a chassis disposed on a rear surface of the panel to fixedly maintain the panel, the chassis being electrically connected to the conductive tape.

Still another aspect of the present invention provides a plasma display panel device including: a panel, a chassis disposed on a back surface of the panel to fixedly maintain the panel, and a film filter attached on a front surface of the panel, having edges extended so as to surround sides of the panel and sides of the chassis, and including an electromagnetic wave absorption layer contacting the chassis.

In one embodiment, the plasma display panel device may further include a conductive frame having a shape corresponding to front corners of the chassis, the conductive frame being fixed onto the chassis so as to maintain the contacting status between the film filter and the chassis.

### BRIEF DESCRIPTION OF THE DRAWINGS

Embodiments of the present invention will be described with reference to the attached drawings.

FIG. 1 is a schematic exploded perspective view of a conventional plasma display panel device.

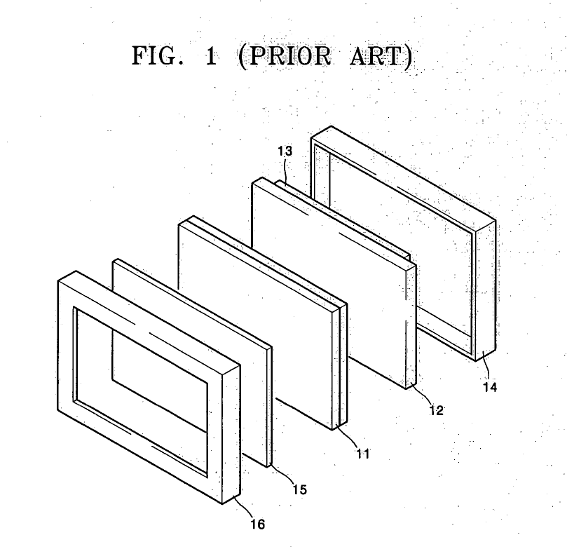

FIG. 2 is a schematic perspective view of a film filter used in a plasma display panel device according to one embodiment of the present invention.

FIG. 3 is a schematic exploded perspective view of a plasma display panel device according to a first embodiment of the present invention.

FIG. 4 is a schematic exploded perspective view of a plasma display panel device according to a second embodiment of the present invention.

FIG. 5 is a schematic exploded perspective view of a plasma display panel device according to a third embodiment of the present invention.

FIG. 6 is a schematic exploded perspective view of a plasma display panel device according to a fourth embodiment of the present invention.

FIG. 7 is a schematic exploded perspective view of a plasma display panel device according to a fifth embodiment of the present invention.

### DETAILED DESCRIPTION OF CERTAIN INVENTIVE EMBODIMENTS

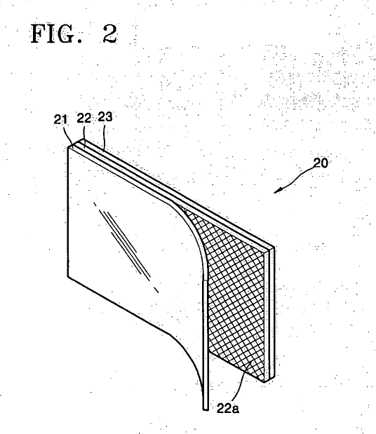

FIG. 2 is a schematic perspective view of a film filter used in a plasma display panel device (PDP) according to one embodiment of the present invention.

Referring to FIG. 2, a film filter 20 is formed by coating a pigment having a desired function or a metal material on a surface of a film formed of, for example, a polyethylene terephthalate (PET) using, for example, an etching or sputtering method. In one embodiment, the film filter 20 can be a multi-layer structure, and the pigment or the metal can be coated on a surface of each layer.

In one embodiment, the film filter 20 includes a plurality of layers, for example, a first layer 21, a second layer 22, and a third layer 23 that are attached to each other. In one embodiment, an electromagnetic wave absorption layer 22a is formed on a surface of the second layer 22. In one embodiment, the film filter 20 can have a single layer structure incorporating the electromagnetic wave absorption layer 22a. In another embodiment, the film filter 20 can have a multilayer structure which can absorb, as a whole of the multilayer, electromagnetic radiation. In one embodiment, the electromagnetic wave absorption layer 22a may be a mesh formed of a metal. In one embodiment, the absorption layer 22a is formed by sputtering or etching a metal of high conductivity such as Ag or Cu in a mesh form. Such a metal mesh layer 22a can effectively absorb the electromagnetic waves generated by the plasma display panel. In another embodiment, the metal layer can have a different pattern from the mesh layer. In one embodiment, the absorbed electromagnetic waves are advantageously grounded. In one embodiment, the layer 22a can be formed from a thin film.

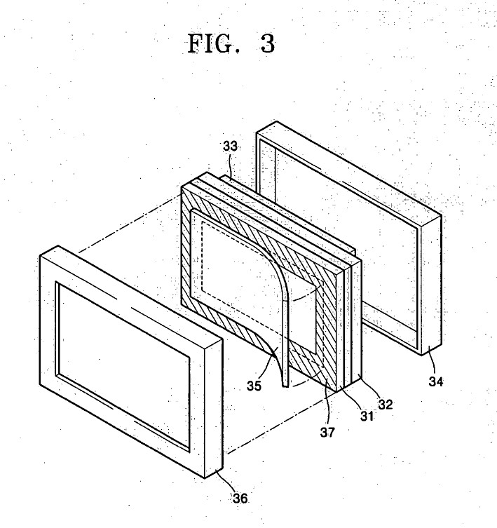

FIG. 3 is a schematic exploded perspective view of a PDP device according to a first embodiment of the present invention.

In one embodiment, the PDP device includes a panel 31, a chassis 32 fixedly maintaining the panel 31, a printed circuit board 33 disposed at a rear surface of the chassis 32. The PDP device typically further includes a front cover 36 and a rear cover 34 defining a space which can receive the panel assembly31, the chassis 32, and the printed circuit board 33 therein.

In one embodiment, a film filter 35 is directly attached onto a surface of the panel 31, and a conductive layer 37 is formed on the surface of the panel 31. In one embodiment, at least a portion of the electromagnetic waves absorption layer 22a (refer to FIG. 2) of the film filter 35 directly contacts the conductive layer 37 so that the absorbed electromagnetic wave can be transmitted (or conducted) to the conductive layer 37. In one embodiment, the conductive layer 37 serves to ground the absorbed electromagnetic wave. In one embodiment, the conductive layer 37 can be formed of a metal, for example, Ag, Au, Cu, Al, Pt, Ni, Pb, Co, Rh, Ru, Sn, Ir, Pd, or Ti. In one embodiment, a silver paste of copper tape extends along the edge of the panel 31 except for an active area of the panel 31. In one embodiment, the conductive layer 37 can be formed of a conductive material using a printing, a sputtering, or a depositing method.

In one embodiment, the film filter 35 electrically contacts the conductive layer 37 on the surface of the panel 31. Ina multi-layered film filter 20 as shown in FIG. 2, the electromagnetic wave absorption layer 22a can be exposed by removing, for example, an edge portion of the first layer 21 or the third layer 23. In one embodiment, the film filter 20 is attached to the panel 31 so that the exposed portion of the layer 22a can contact the conductive layer 37 as shown in FIG. 3. In this way, the electromagnetic wave absorbed by the layer 22a can be transmitted to and grounded through the conductive layer 37. In one embodiment, the conductive layer 37 may be connected to the chassis 32 through another electrical path. In another embodiment, the conductive layer 37 can be connected to another element of the PDP device which can ground the conducted electromagnetic wave.

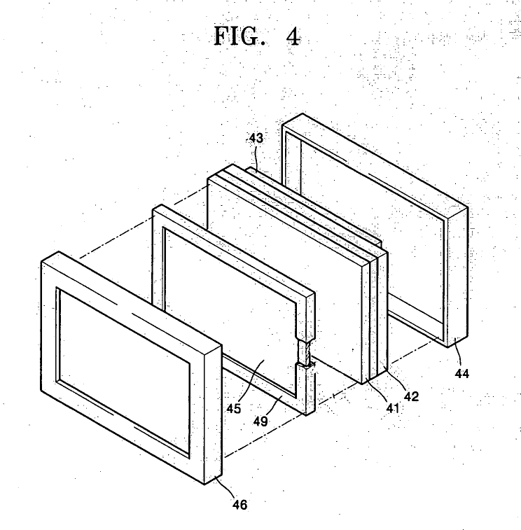

FIG. 4 is a schematic exploded perspective view of a PDP device according to a second embodiment of the present invention.

The PDP device of FIG. 4 includes the same elements as the FIG. 3 embodiment, for example, a panel 41, a chassis 42, a printed circuit board 43, a film filter 45, and a front cover 46 and a back cover 44.

In this embodiment, the film filter 45 is surrounded by a conductive tape 49 along its edge area as shown in FIG. 4. In one embodiment, the conductive tape 49 surrounds the opposing edge areas (for example, the edge area of the first layer 21 and the edge area of the third layer in FIG. 2) of the film filter 45 as shown in FIG. 4. It is assumed that in FIG. 2 the electromagnetic wave absorption layer 22a is exposed to the outside by removing a portion of one of the edge areas of the first and third layers 21 and 23. Referring back to FIG. 4, since the conductive tape 49 surrounds and contacts the entire edge areas of the first and third layers 21 and 23, the absorption layer 22a is electrically connected to the conductive tape 49 via the exposed portion, which is a part of the edge areas. In this way, the electromagnetic wave absorbed in the layer 22a is conducted to the conductive tape 49 via the exposed portion (not shown) of the film filter 45. In one embodiment, the conductive tape 49 serves to ground the absorbed electromagnetic wave as in the conductive layer 37 of FIG. 3. In one embodiment, the conductive tape 49 can be electrically connected to the chassis 42 so that the electromagnetic wave, transmitted from the layer 22a, can be more effectively grounded via the chassis 42. In one embodiment, the conductive tape 49 and the chassis 42 can be connected to each other by extending the conductive tape 49 to the chassis 42.

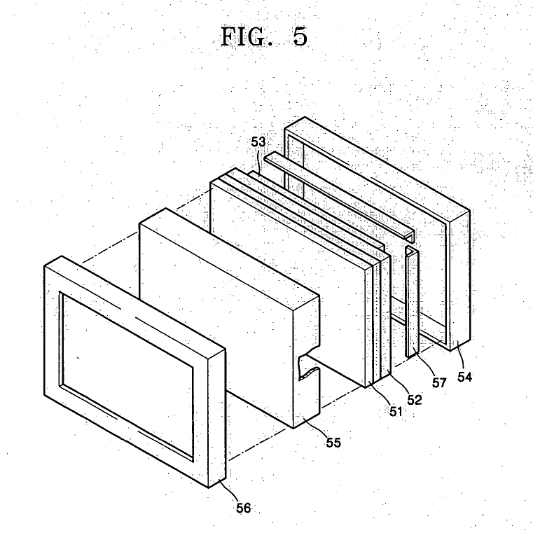

FIG. 5 is a schematic exploded perspective view of a plasma display panel device according to a third embodiment of the present invention.

The PDP device of FIG. 5 includes the same elements as the FIG. 3 embodiment, for example, a panel 51, a chassis 52, a printed circuit board 53, and a front cover 56 and a back cover 54.

In this embodiment, a film filter 55 disposed on a front surface of the panel 51 has an edge extending toward the chassis 52 as shown in FIG. 5. In this embodiment, the electromagnetic wave absorption layer 22a also extends to the chassis 52, and at least a portion of the layer 22a contacts the chassis 52. Since the film filter 55 passes over the edge of the panel 51 and extends to the chassis 52, the film filter 55 can directly contact the surface of the chassis 52. In one embodiment, a fixing member 57 is provided to maintain the direct contact status between the filter 55 and the chassis 52. In one embodiment, the fixing member 59 has a shape corresponding to the corners of the chassis 52, and is fixed onto the chassis 52 while pressing the edge of the film filter 55 onto the chassis 52.

In FIG. 5 embodiment, since the film filter 55 extends to and directly contacts the chassis 52, the electromagnetic wave generated from sides of the panel 51 can be shielded, as well as the wave generated from the front surface of the panel 51.

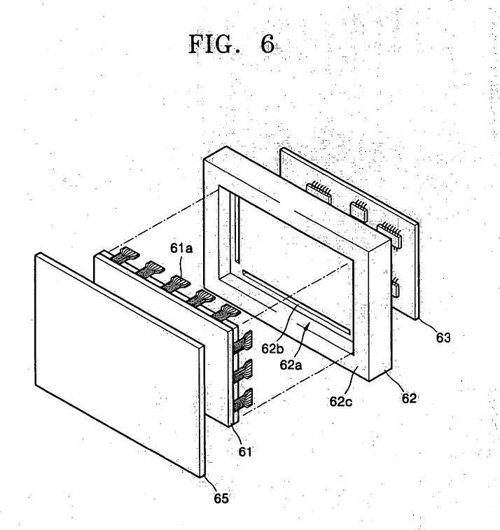

FIG. 6 is a schematic exploded perspective view of a plasma display panel device according to a fourth embodiment of the present invention.

The PDP device of FIG. 6 includes the same elements as the FIG. 3 embodiment, for example, a panel 61, a chassis 62, a printed circuit board 63, and a front cover and a rear cover (not shown). In this embodiment, the chassis 62 includes a receiving portion 62a that can receive the panel 61 as shown in FIG. 6. In addition, a cable passage recess 62b is formed in the panel receiving portion 62a formed in the chassis 62, and the cable passage recess 62b extends to the rear surface of the chassis 62. Furthermore, a flexible printed cable 61a extending from an electrode formed on the panel 61 passes through the cable passage recess 62b. A terminal of the flexible printed cable 61a is connected to a connection unit of the printed circuit board 63.

Referring to FIG. 6, the surface of the panel 61 and a front surface 62c of the chassis 62 are located at the same height so that the panel 61 is inserted into the panel receiving portion 62a of the chassis 62. Furthermore, when the film filter 65 is attached on the front surface of the panel 61, the edge of the film filter 65 can contact the front surface 62c of the chassis 62. Therefore, the electromagnetic wave absorption layer 22a (refer to FIG. 2)of the film filter 65 contacts the front surface 62c of the chassis 62, and the absorbed electromagnetic wave can be grounded via the chassis 62.

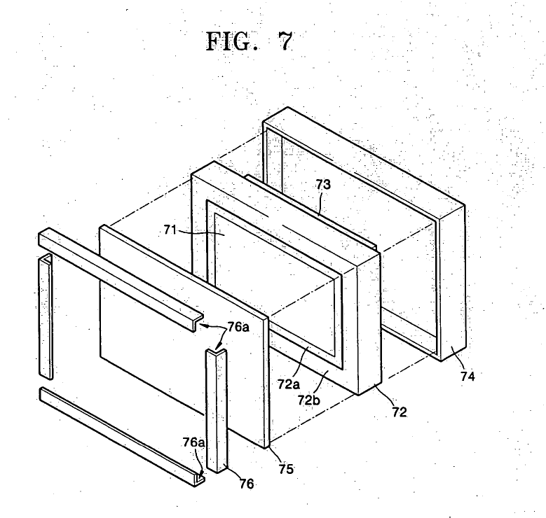

FIG. 7 is a schematic exploded perspective view of a plasma display panel device according to a fifth embodiment of the present invention.

Referring to FIG. 7, the PDP device of FIG. 7 is substantially the same as the apparatus of FIG. 6. That is, the PDP device of FIG. 7 includes a panel 71, a chassis 72 including a receiving portion 72a that can receive the panel 71 therein, and a printed circuit board 73. The panel 71, the chassis 72, and the printed circuit board 73 are received in a space defined by a rear cover 74 and a front cover (not shown). The panel 71 is inserted into the receiving portion 72a of the chassis 72. In this embodiment, a film filter 75 can be attached to both of the surface of the panel 71 and the front surface 72b of the chassis 72.

In one embodiment, the PDP device further includes a conductive frame 76 as shown in FIG. 7. The conductive frame 76 is a member including receiving portions 76a corresponding to the corners of the chassis 72, and is formed of a conductive material. In one embodiment, the conductive frame 76 may be disposed inside of the front cover 36, 46, or 56 shown in FIGS. 3 through 5. In another embodiment, the front cover (not shown) may be formed of the conductive material and the conductive frame 76 may be omitted. Since the conductive frame 76 contacts the both edges of the film filter 75 and the chassis 72 so as to surround the edges together, the conductive frame 76 more effectively grounds the electromagnetic wave that has been conducted through the film filter 75 and the chassis 72. That is, the conductive frame 76 is disposed so as to surround a portion of the chassis 72, which the electromagnetic wave absorption layer 22a (refer to FIG. 2) of the film filter 75 contacts, and thus, enhancing the ground effect of the conducted electromagnetic wave.

The conductive frame 76 shown in FIG. 7 can be applied to the PDP devices of other embodiments, for example, in the PDP devices of FIGS. 3 through 5, the conductive frame corresponding to the corners of the panel 31, 41 or 51 can be installed in the front cover 36, 46, or 56, and the conductive frame is electrically connected to the electromagnetic wave absorption layer 22a of the film filter 35, 45, or 55. In addition, the rear cover may be formed of the conductive material, and is electrically connected to the electromagnetic wave absorption layer of the film filter, and thus, the electromagnetic wave can be grounded.

The PDP devices including the film filters according to the first through third embodiments of the present invention described with reference to FIGS. 3 through 5 showed high electromagnetic wave shielding performance than that of the apparatus not including the filter. The following table shows some experimental results.

| | | Measured electromagnetic wave values | |
|---|---|---|---|
| | | (dBuV/m, Max value at 30˜300 MHz) | |
| Sample | | Horizontal | Vertical |
| number | Content | frequency | frequency |
| Comparative | No filter | 57.37 (220.4 MHz) | 59.14 (220.4 MHz) |
| example | | | |
| First | Forming | 32.97 (200.1 MHz) | 31.14 (100.2 MHz) |
| embodiment | grounding | | |
| | surface on | | |
| | panel glass | | |
| Second | Forming | 35.93 (140.0 MHz) | 31.12 (65.8 MHz) |
| embodiment | grounding | | |
| | surface | | |
| | using tape | | |
| Third | Extending | 27.22 (279.84 MHz) | 32.28 (59.7 MHz) |
| embodiment | filter to | | |
| | chassis | | |

The values in the table are the approximate measured maximum values of the electromagnetic wave parameter, and values in parentheses represent the corresponding approximate frequency maximum values.

As shown in the above table, the PDP devices according to the first through third embodiments of the present invention show much lower electromagnetic wave values than that of the apparatus including no filter.

According to embodiments of the present invention, the PDP device includes an electromagnetic wave absorption filter, attached to a surface of the panel, in order to reduce the weight and thickness of the entire apparatus. Furthermore, a structure for easily grounding the electromagnetic wave absorbed by the film filter can be provided.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A plasma display panel device, comprising:
a panel;
a conductive layer formed along an edge of a front surface of the panel; and
a film filter, contacting the front surface of the panel, including an electromagnetic wave absorption layer at least a portion of which contacts the conductive layer, wherein the electromagnetic wave absorption layer is configured to absorb electromagnetic waves emitted from the front surface of the panel.

2. The plasma display panel device of claim 1, wherein the conductive layer is formed of at least one of the following metals: Ag, Au, Cu, Al, Pt, Ni, Pb, Co, Rh, Ru, Sn, Ir, Pd, and Ti.

3. The plasma display panel device of claim 1, wherein the conductive layer is formed by one of the following: printing, sputtering, and depositing a paste.

4. The plasma display panel device of claim 1, further comprising a chassis disposed on a rear surface of the panel to fixedly maintain the panel, the chassis being electrically connected to the conductive layer.

5. The plasma display panel device of claim 4, further comprising a front cover and a rear cover receiving the panel, the film filter, and the chassis therein.

6. A plasma display panel device, comprising:
a panel;
a film filter attached on a front surface of the panel and including an electromagnetic wave absorption layer; and
a conductive tape surrounding an edge area of the film filter and attached to at least a portion of the electromagnetic wave absorption layer.

7. The plasma display panel device of claim 6, further comprising a chassis disposed on a rear surface of the panel to fixedly maintain the panel, the chassis being electrically connected to the conductive tape.

8. The plasma display panel device of claim 7, further comprising a front cover and a rear cover receiving the panel, the film filter, and the chassis therein.

9. A plasma display panel device, comprising:
a panel;
a chassis disposed on a rear surface of the panel to fixedly maintain the panel; and
a film filter attached on a front surface of the panel, having edges extended so as to surround side surfaces of the panel and side surfaces of the chassis, and including an electromagnetic wave absorption layer at least a portion of which contacts the chassis, wherein the side surfaces are substantially perpendicular to the front surface of the panel.

10. The plasma display panel device of claim 9, further comprising a fixing member configured to attach the extended edges of the film filter onto the chassis.

11. The plasma display panel device of claim 9, further comprising a front cover and a rear cover receiving the panel, the film filter, and the chassis therein.

12. A plasma display panel device, comprising:
a panel;
a chassis including i) a panel receiving portion configured to receive the panel, and ii) a cable passage recess, through which a flexible printed cable extended from the panel can pass toward a rear surface of the chassis; and
a film filter attached on a front surface of the panel and including an electromagnetic wave absorption layer at least a portion of which contacts the chassis.

13. The plasma display panel device of claim 12, further comprising a conductive frame configured to surround an edge area of the film filter and maintain the attached status between the film filter and the chassis.

14. The plasma display panel device of claim 13, further comprising a front cover and a rear cover receiving the panel, the film filter, the chassis, and the conductive frame therein.

15. A plasma display panel device, comprising:
a panel; and
a film filter, contacting a surface of the panel, including an electromagnetic wave absorption layer, wherein the electromagnetic wave absorption layer is configured to absorb electromagnetic waves emitted from the surface of the panel.

16. The plasma display panel device of claim 15, further comprising a conducting member configured to conduct the absorbed electromagnetic waves to another element of the plasma display panel device.

17. The plasma display panel device of claim 16, wherein the conducting member is one of the following: i) a conductive layer formed along an edge of a front surface of the panel and configured to contact at least a portion of the electromagnetic wave absorption layer and ii) a conductive tape surrounding an edge area of the film filter and attached to at least a portion of the electromagnetic wave absorption layer.

18. The plasma display panel device of claim 15, wherein the film filter includes an edge extended to and contacting a chassis, wherein at least a portion of the electromagnetic wave absorption layer is electrically connected to the chassis.

19. A plasma display panel device, comprising:
means for absorbing electromagnetic waves emitted from a surface of a panel of the plasma display panel device and directly contacting the panel surface; and
means for transmitting the absorbed electromagnetic waves to another element of the plasma display panel device.

20. A structure for a plasma display panel device, the structure comprising:
a film filter configured to absorb electromagnetic waves emitted from a surface of a panel of the plasma display panel device and to be affixed to the panel surface.

21. The structure of claim 20, wherein the film filter includes a plurality of layers, and wherein one of the plurality of layers is an electromagnetic wave absorption layer.

22. The structure of claim 21, wherein the electromagnetic wave absorption layer is formed of a metal in a mesh pattern.
